(19) United States
(12) Patent Application Publication
(10) Pub. No.: US 2026/0028480 A1
(43) Pub. Date: Jan. 29, 2026

(54) FLAME-RETARDANT IMPACT-MODIFIED THERMOPLASTIC COMPOSITIONS

(71) Applicant: SABIC GLOBAL TECHNOLOGIES B.V., Bergen op Zoom (NL)

(72) Inventors: Rein Mollerus FABER, Bergen op Zoom (NL); Prashant PATIL, Bangalore (IN); Subodh Kumar PAL, Bangalore (IN); Himanshu ASTHANA, Evansville, IN (US)

(21) Appl. No.: 18/997,952

(22) PCT Filed: Jun. 27, 2023
(86) PCT No.: PCT/EP2023/067428

§ 371 Date: Jan. 23, 2025

(30) Foreign Application Priority Data
Jul. 27, 2022 (EP) 22187155.1

(51) Int. Cl. C08L 69/00; C08K 3/34; C08K 5/103; C08K 5/521; C08K 5/524; C08K 5/5399

(52) U.S. Cl. CPC C08L 69/00; C08K 3/34; C08K 5/521; C08K 5/5399; C08K 5/103; C08K 5/524; C08L 2205/025; C08L 2205/035; C08L 2207/53

(57) ABSTRACT

The present invention relates to a thermoplastic composition comprising, based on the weight of the composition, (A) 60 to 95 wt. % of aromatic polycarbonate, (B) 3 to 15 wt. % of impact modifier, (C) 2 to 20 wt. % of a flame-retardant additive comprising at least one cyclic phosphazene (C-1) and at least one oligomeric phosphate (C-2) (D) 0 to 5 wt. % of other components; wherein, the combined amounts of (A) to (D) is 100 wt. %, and wherein the composition has: —a notched Izod impact resistance determined in accordance with ASTM D-256 at a temperature of 23° C. of at least 300 J/m, preferably from 300-900 J/m; —a melt flow rate determined in accordance with ASTM D1238 (300° C., 1.2 kg) of at least 7.0 g/10 min, preferably between 7.0-20.0 g/10 min; and —a UL94 rating of V0 at a thickness of 0.75 mm.

### CROSS REFERENCE TO RELATED APPLICATIONS

This application is a National Stage application of PCT/EP2023/067428, filed Jun. 27, 2023, which claims the benefit of European Application No. 22187155.1, filed Jul. 27, 2022, both of which are incorporated by reference in their entirety herein.

### BACKGROUND

The present invention relates to a flame-retardant (FR) impact-modified thermoplastic composition comprising aromatic polycarbonate, impact modifier and a blend of flame retardant additives. The present invention further relates to an article comprising or consisting of such a composition.

Such compositions are known per se in the prior art and may be used in interior or exterior automotive applications and also in electrical & electronic applications such as mobiles, notebooks, monitors, tablets, data storage etc., computer, (tele) communication applications, across other different segments and applications such as consumer products & appliances, automotive lighting, automotive under the hood, electric vehicle applications, electrical parts, electronic displays, energy storage and lighting applications.

In many of these applications there is a trend towards parts that, at least partially, have a relatively small wall thickness. As a result the thermoplastic compositions used for the manufacture of such applications requires an optimized set of flow and mechanical properties, such as in particular impact and stiffness, while maintaining good flame retardancy, such as in particular a UL V0 rating.

US 2016/0194495 discloses a blended thermoplastic composition comprising: a) from about 60 wt % to about 80 wt. % of a polycarbonate component, the polycarbonate component comprising 5-15 wt. % polycarbonate-polysiloxane copolymer based on total weight of the composition; b) from greater than about 0 wt. % to about 5 wt. % of an impact modifier component; c) from greater than about 0 wt. % to about 25 wt. % of a mineral filler component; and d) from about 5 wt. % to about 15 wt. % of a flame retardant component; wherein the combined weight percent value of all components does not exceed about 100 wt. %; and wherein all weight percent values are based on the total weight of the composition.

US 2019/0255825 discloses a fibre composite material comprising at least one layer of fibre material embedded into an aromatic polycarbonate-based composition comprising A) aromatic polycarbonate, B) 1% by weight to 14% by weight of talc, C) 7% by weight to 15% by weight of at least one cyclic phosphazene of formula (1)

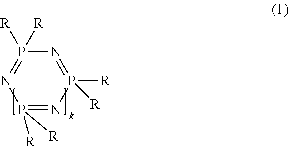

Where R is the same or different and is an amine radical, an in each case optionally halogenated C₁- to C₈-alkyl radical, C₁- to C₈-alkoxy radical, in each case optionally alkyl- and/or halogen-substituted C₅- to C₆ ccycloalkyl radical, in each case optionally alkyl and/or halogen- and/or hydroxyl-substituted C₆ to C₂-aryloxy radical, in each case optionally alkyl and/or halogen-substituted C₇- to C₁₂-aralkyl radical or a halogen radical or an OH radical, k is an integer from 1 to 10, D) 0% to 11% by weight of at least one phosphorus compound of the general formula (V)

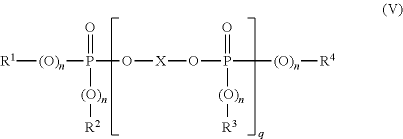

Where R¹, R², R³ and R⁴ are each independently a C₁- to C₈-alkyl radical, in each case optionally halogenated and in each case branched or unbranched, and/or C₅ to C₆-cycloalkyl radical, C₆- to C₂-aryl radical or C₇- to C₁₂-aralkyl radical, in each case optionally substituted by branched or unbranched alkyl and/or halogen, n is independently 0 or 1, q is an integer from 0 to 30, X is a mono- or polycyclic aromatic radical having 6 to 30 carbon atoms or a linear or branched aliphatic radical having 2 to 30 carbon atoms, each of which may be substituted or unsubstituted, and bridged or unbridged; E) 0% to 0.2% by weight of at least one stabilizer selected from the group consisting of alkyl phosphate, ethylenediaminetetraacetic acid and/or citric acid,

F) optionally further additives, wherein the composition is free of PTFE.

### SUMMARY

In view of the foregoing, an object of the present invention is to provide a thermoplastic composition having a desired combination of thin wall flame retardancy, impact resistance, stiffness and flow which allows it to be suitable for the manufacture of thin walled structural parts.

This object is met, at least in part, in accordance with the present invention which is directed at a thermoplastic composition comprising, based on the weight of the composition,
(A) 60 to 95 wt. % of aromatic polycarbonate,
(B) 3 to 15 wt. % of impact modifier,
(C) 2 to 20 wt. % of a flame-retardant additive comprising at least one cyclic phosphazene (C-1) and at least one oligomeric phosphate (C-2)
(D) 0 to 5 wt. % of other components;
wherein, the combined amounts of (A) to (D) is 100 wt. %,
and wherein the composition has, or is selected to have:
   a notched Izod impact resistance determined in accordance with ASTM D-256 at a temperature of 23° C. of at least 300 J/m, preferably from 300-900 J/m;
   a melt flow rate determined in accordance with ASTM D1238 (300° C., 1.2 kg) of at least 7.0 g/10 min, preferably between 7.0-20.0 g/10 min; and
   a UL94 rating of V0 at a thickness of 0.75 mm.

### DETAILED DESCRIPTION

The invention will now be described in more detail.

### Polycarbonate (PC)

Aromatic polycarbonates are generally manufactured using two different technologies. In a first technology, known as the interfacial technology or interfacial process, phosgene is reacted with a bisphenol, typically bisphenol A (BPA) in a liquid phase. Another well-known technology is the so-called melt technology, sometimes also referred to as melt transesterification or melt polycondensation technology. In the melt technology, or melt process, a bisphenol, typically BPA, is reacted with a carbonate, typically diphenyl carbonate (DPC), in the melt phase. Aromatic polycarbonate obtained by the melt transesterification process is known to be structurally different from aromatic polycarbonate obtained by the interfacial process. In that respect, it is noted that in particular, the so called “melt polycarbonate” typically has a minimum amount of Fries branching, which is generally absent in “interfacial polycarbonate”. Apart from that, melt polycarbonate typically has a higher number of phenolic hydroxy end groups while polycarbonate obtained by the interfacial process is typically end-capped and has at most 150 ppm, preferably at most 50 ppm, more preferably at most 10 ppm of phenol hydroxyl end-groups.

The thermoplastic composition of the present invention comprises, as a component (A), 60 to 95 wt. %, preferably 70 to 90 wt. % of aromatic polycarbonate, based on the weight of the composition. In accordance with the invention, it is preferred that the aromatic polycarbonate comprises or consists of bisphenol A polycarbonate homopolymer (also referred to herein as bisphenol A polycarbonate) or a mixture of bisphenol A polycarbonates. Preferably, the aromatic polycarbonate of the invention disclosed herein comprises at least 75 wt. %, preferably at least 95 wt. % of bisphenol A polycarbonate based on the total amount of aromatic polycarbonate. More preferably, the aromatic polycarbonate in the composition essentially consists or consists of bisphenol A polycarbonate. It is preferred that the aromatic polycarbonate has a weight average molecular weight (Mw) of 15,000 to 60,000 g/mol determined using gel permeation chromatography with polycarbonate standards.

In an aspect, the polycarbonate is an interfacial polycarbonate.

In another aspect, the polycarbonate is a melt polycarbonate.

In yet another aspect, the polycarbonate is a mixture of from 20-80 wt. % or 40-60 wt. % of interfacial polycarbonate and from 80-20 wt. % or 60-40 wt. % of melt polycarbonate, based on the weight of the aromatic polycarbonate.

The polycarbonate may be a mixture of two or more aromatic polycarbonates differing in melt flow rates. For example, the aromatic polycarbonate may be a mixture of two or more bisphenol A polycarbonate homopolymers with mutually different weight average molecular weight. The polycarbonate can have a melt flow rate, determined in accordance with ASTM D1238 (300° C., 1.2 kg) of 1 to 50 g/10 min, specifically 2 to 30 cc/10 min. In another aspect the polycarbonate comprises a polycarbonate copolymer comprising structural units of bisphenol A and structural units from another bisphenol.

The aromatic polycarbonate preferably does not comprise from 5-15 wt. %, based on the weight of the thermoplastic composition, of polycarbonate-polysiloxane copolymer. Preferably the aromatic polycarbonate does not comprise polycarbonate-polysiloxane copolymer. More preferably the thermoplastic composition does not comprise a polycarbonate-polysiloxane copolymer in an amount of at least 3 wt. %. Even more preferably the thermoplastic composition does not comprise a polycarbonate-polysiloxane copolymer.

### Impact Modifier

The thermoplastic composition of the invention comprises, as a component (B), an impact modifier. Suitable impact modifiers are typically high molecular weight elastomeric materials derived from olefins, monovinyl aromatic monomers, acrylic and methacrylic acids and their ester derivatives, as well as conjugated dienes. The polymers formed from conjugated dienes can be fully or partially hydrogenated. The elastomeric materials can be in the form of homopolymers or copolymers, including random, block, radial block, graft, and core-shell copolymers. Combinations of impact modifiers can be used.

The impact modifier is preferably selected from the group consisting of acrylonitrile-butadiene-styrene impact modifiers, methyl methacrylate-butadiene-styrene impact modifiers, ethylene-acrylate copolymer impact modifiers, ethylene-acrylate-glycidyl copolymer impact modifiers and mixtures of two or more of the foregoing.

It is preferred that the impact modifier is selected from the group consisting of acrylonitrile-butadiene-styrene impact modifiers and methyl methacrylate-butadiene-styrene impact modifiers and/or mixtures of the two.

The amount of impact modifier is from 3-15 wt. % based on the weight of the composition. Preferably the impact modifier is comprised in the composition in an amount of from 3-10 wt. %, preferably from 4-8 wt. %.

In another preferred aspect, the thermoplastic composition further comprises 1 to 5 wt. % of a silicon-acrylate composite rubber comprising a polyorganosiloxane rubber component and a polyalkyl (meth)acrylate rubber component. Silicon-acrylate composite rubber are known and are described, for example, in U.S. Pat. No. 5,807,914, EP 0430134 and U.S. Pat. No. 4,888,388 and the references therein.

Suitable silicone rubber components of the silicone/acrylate rubbers are silicone rubbers having grafting-active sites, the preparation method of which is described, for example, in U.S. Pat. Nos. 2,891,920, 3,294,725, EP0249964, EP 0430134 and U.S. Pat. No. 4,888,388 and the references therein. Such a silicon-acrylate composite rubber is preferably a composite rubber having a graft active site, and contains 10 to 90% by weight of a silicon rubber component and 90 to 10% by weight of a polyalkyl (meth)acrylate rubber component. The two rubber components described are interpenetrated into the composite rubber so that they cannot be substantially separated.

### Flame Retardant Additive

Phosphorus-containing compounds are commonly employed as the FR additive in thermoplastic compositions. These are selected from the groups of mono- and oligomeric phosphoric and phosphonic acid esters, phosphonatamines and phosphazenes. It is also possible to employ mixtures of several components chosen from one or several of these groups as the FR additives. The thermoplastic composition, in accordance with the present invention, comprises, based on the weight of the composition, 2 wt. % to 20 wt. % of a FR additive comprising at least one cyclic phosphazene (C-1) and at least one oligomeric phosphate (C-2).

The at least one phosphazenes (C-1) is a cyclic phosphazene, preferably selected from the group consisting of propoxyphosphazene, phenoxyphosphazene, methylphenoxyphosphazene, aminophosphazene and fluoroalkylphosphazenes and phosphazenes having the following structure (X)

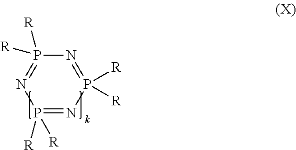

where:
   the radicals R are identical or different and are each
      an amine radical,
      in each case optionally halogenated, preferably fluorinated, more preferably monohalogenated, C₁-C₈-alkyl, preferably methyl, ethyl, propyl or butyl,
      C₁- to C₈-alkoxy, preferably methoxy, ethoxy, propoxy or butoxy,
      C₅- to C₆-cycloalkyl which is in each case optionally substituted by alkyl, preferably C₁- to C₄-alkyl, and/or halogen, preferably chlorine and/or bromine,
      C₆- to C₂₀-aryloxy, preferably phenoxy, naphthyloxy, which is in each case optionally substituted by alkyl, preferably C₁- to C₄-alkyl, and/or halogen, preferably chlorine, bromine, and/or hydroxy,
      C₇- to C₁₂-aralkyl, preferably phenyl-C₁- to C₄-alkyl, which is in each case optionally substituted by alkyl, preferably C₁- to C₄-alkyl, and/or halogen, preferably chlorine and/or bromine, or
      a halogen radical, preferably chlorine or fluorine, or
      an OH radical, and
   k is 1 or an integer from 1 to 10, preferably a number from 1 to 8, particularly preferably from 1 to 5.

Preferably C-1 is a cyclic phosphazene having a proportion of oligomers having k=1 (trimer) from 50 to 98 mol % preferably from 70 to 90 mol % and more preferably 70-85 mol %. More preferably, C-1 is phenoxyphosphazene (all radicals R=phenoxy) (X-1) having a proportion of oligomers having k=1 from 50 to 98 mol %.

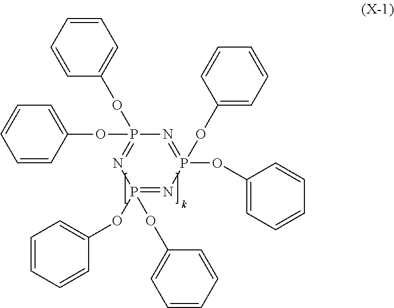

The phosphazenes can be used either alone or as a mixture. The radicals R in the structure (X) can be the same or different. The radicals R of a phosphazene are preferably identical. In a further preferred embodiment, only phosphazenes having identical radicals R are used.

In a preferred aspect, the proportion of tetramers (k=2) is from 2 to 50 mol %, based on the component C-1, preferably from 5 to 40 mol %.

In yet another aspect, the proportion of the higher oligomeric phosphazenes (k=3, 4, 5, 6 and 7) is from 0 to 30 mol %, based on the component C-1, preferably from 2 to 25 mol %.

In yet another aspect, the proportion of oligomers having k≥8 is from 0 to 2 mol %, based on the component C-1, preferably from 0.1 to 1 mol %.

Most preferably, the component C-1 comprises phenoxyphosphazene having a proportion of trimer (k=1) of from 70 to 85 mol %, a proportion of tetramer (k=2) of from 10 to 20 mol %, a proportion of higher oligomeric phosphazenes (k=3, 4, 5, 6 and 7) of from 6 to 15 mol % and phosphazene oligomers having k≥8 of from 0.1 to 1 mol %, based on the component C-1.

Oligomeric phosphates as component C-2 which are used according to the present invention are preferably selected from the group consisting of bisphenol A bis (diphenyl phosphate), resorcinol (diphenyl phosphate), oligomeric solid phosphate ester and mixtures of two or more of the foregoing.

The flame retardants can be used along with other flame retardants apart from the group C-1 and C-2. However, preference is given to no further flame retardants apart from the flame retardants of the group C-1 and/or C-2 used. The wt. % ratio of C-1 to C-2 is from 10:90 to 90:10, preferably from 25:75 to 75:25, more preferably from 30:60 to 60:30.

### Other Components

The thermoplastic composition in accordance with the present invention comprises, based on the weight of the composition 0 to 5 wt. %, preferably 0 to 3 wt. %, more preferably at most 2 wt. % of other components.

In particular, polytetrafluoroethylene (PTFE) or a PTFE-containing composition, for example masterbatches of PTFE with styrene or methyl methacrylate-containing polymers or copolymers or SAN encapsulated PTFE is used as anti-drip agent. Particularly preferred other components in accordance with the present invention contain based on the weight of the composition, from 0.01 to 2 wt. % of anti-drip agent, preferably selected from one or more of PTFE and SAN encapsulated PTFE, in addition to optional further additives.

In another aspect the other components in accordance with the present invention comprises, based on the weight of the composition, from 0.01 to 3 wt. % of one or more selected from the group consisting of talc, kaolin, mica. Preferably the other components, and accordingly the thermoplastic composition, does not comprise talc.

Other components that are used in the composition can comprise one or more of flame retardant synergists, lubricants and mold release agents (for example pentaerythritol tetrastearate), nucleating agents, stabilizers, antistatics (for example conductive carbon blacks, carbon fibers, carbon nanotubes and organic antistatics, such as polyalkylene ethers, alkylsulfonates or polyamide-containing polymers), acids, fillers and reinforcing substances (for example glass fibers or carbon fibers, mica, kaolin, talc, CaCO3 and glass flakes) and dyestuffs and pigments.

### Composition

The combination of specific types and amounts materials constituting the thermoplastic composition results in a property profile in terms of in particular FR performance, toughness, stiffness and flow. The examples and comparative examples disclosed herein provide the skilled person with materials that fall inside and outside the scope of the invention and thereby constitute a basis for the development of further embodiments according to the invention without undue burden.

In accordance with the invention the thermoplastic composition comprises
A. 60 to 95 wt. % of aromatic polycarbonate,
B. 3 to 15 wt. % of impact modifier,
C. 2 to 20 wt. % of a flame-retardant additive comprising at least one cyclic phosphazene (C-1) and at least one oligomeric phosphate (C-2)
D. 0 to 5 wt. % of other components;
wherein, the combined amounts of (A) to (D) is 100 wt. %,

In this composition the amount of aromatic polycarbonate is preferably from 70 to 90 wt. %. The amount of impact modifier is preferably from 2 to 12 wt. %. The amount of flame retardant additive is preferably from 2 to 15 wt. %. The amount of other components is preferably be from 1 to 3 wt. %.

For the avoidance of doubt the skilled person will understand that the total weight of the composition will be 100 wt. % and that any combination of materials which would not form 100 wt. % in total is unrealistic and not according to the invention.

In accordance with the invention the thermoplastic composition is selected to have
a notched Izod impact resistance determined in accordance with ASTM D-256 at a temperature of 23° C. of at least 300 J/m;
a melt flow rate determined in accordance with ASTM D1238 (300° C., 1.2 kg) of at least 7.0 g/10 min; and
a UL94 rating of V0 at a thickness of 0.75 mm.

The notched Izod impact strength may be from 300-900 J/m

The melt flow rate may be from 7.0-20.0 g/10 min, preferably from 10.0-18.0 g/10 min, more preferably from 12.0-16.0 g/10 min.

It is preferred that the composition further has a heat distortion temperature of at least 90° C., preferably at least 95° C., more preferably at least 100° C. as determined in accordance with ASTM D648 standard at a load of 0.45 MPa.

Preferred ranges for the amount of the components and preferred ranges for the properties of the composition may be combined without limitation provided of course these fall within the ambit of the scope of the invention as defined herein in its broadest form. That is to say, a preferred range for one or more of the amounts and/or types of the components constituting the thermoplastic composition may be combined with a preferred range for one or more of the properties of the thermoplastic composition and all such combinations are considered as disclosed herein.

The compositions can be manufactured by various methods known in the art. For example, polycarbonate, impact modifiers, flame retardant additives and other additives are first blended, in a high-speed mixer or by hand mixing. The blend is then fed into the throat of a twin-screw extruder via a hopper. Alternatively, at least one of the components can be incorporated into the composition by feeding it directly into the extruder at the throat and/or downstream through a side feeder, or by being compounded into a masterbatch with a desired polymer and fed into the extruder. For example, compositions can be prepared using a Krupp Werner & Pfleiderer ZSK2 co-rotating intermeshing 10-barrel twin screw extruder of diameter 25 mm and L/D ratio 41. The temperature in the extruder may be from 180° C.-265° C. along the screw length. The extrudate can be immediately cooled in a water bath and pelletized. The pellets so prepared can be 0.6 cm in length or less as desired. Such pellets can be used for subsequent molding, shaping, or forming.

Shaped, formed, or molded articles comprising the compositions are also provided. The compositions can be molded into articles by a variety of methods, such as injection molding, extrusion, and thermoforming. Some example of articles include articles used in interior or exterior automotive applications and also in electrical & electronic applications such as software products (mobiles, notebooks, monitors, tablets, data storage etc.) computer and (tele) communication applications and across other different segments and applications such as consumer products & appliances, automotive lighting, automotive under the hood, electric vehicle applications, electrical parts, electronic displays, energy storage and lighting applications.

Accordingly, the present invention relates to an article comprising or consisting of the composition disclosed herein. More in particular, the present invention relates to manufacture of an article, preferably an automotive part or electrical or electronic part comprising or consisting the composition disclosed herein. Likewise, the present invention relates to a vehicle or an electrical or electronic equipment comprising said vehicular part or said electrical or electronic part.

The present invention will now be further elucidated based on the following non-limiting examples.

### Test Methods

| | |
|---|---|
| Impact | Notched Izod impact (NII) properties were determined in |
| | accordance with ASTM D256 on injection molded samples of |
| | thickness 3.2 mm. The test was carried out at different |
| | temperatures 23° C. and 0° C. The impact strength is expressed |
| | in J/m. The test result presented herein is the average of 5 |
| | specimens. |
| Molecular weight | The molecular weight of the polycarbonate was measured by GPC |
| | method with polycarbonate standard in an Agilent 1260 Infinity |
| | (SYS-LC-1260) equipment with PLGel 5 μm Minimix C 250 × 4.6 mm |
| | column and Refractive Index detector. The sample is dissolved |
| | in dichloromethane and the same solvent is used as carrier. |
| Heat distortion | The heat distortion temperature, HDT (in ° C.) was determined |
| temperature (HDT) | in accordance with ASTM D648 standard at a load of 0.45 MPa. |
| Flammability | UL 94 V (measured on bars of dimensions 127 × 12.7 × 1.0 mm |
| | and 127 × 12.7 × 0.75 mm respectively. |
| | The total flameout time (TFOT) is the sum of the time, in seconds |
| | (s) measured according to the process described in UL-94 V test. |
| | The test result presented herein is the average of 5 specimens. |
| Melt flow rate | The melt flow rate was determined in accordance with ASTM |
| (MFR) | D1238. Measurements were carried out at a temperature of |
| | 300° C. and a load of 1.2 kg. |

### EXAMPLES

The samples were molded by injection molding on L&T ASWA 100T Injection molding machine 5 set from 40-280° C., keeping the mold temperature set at 70° C. for all compositions. The components of the compositions and their source are listed in Table 1.

TABLE 1
Components of the compositions and their source

| Component | Trade name/Supplier |
|---|---|
| PC1 | Bisphenol A polycarbonate manufactured using an interfacial process, |
| | having a melt volume rate of 6 cc/10 min (ISO 1133, 300° C., 1.2 kg) and |
| | weight average molecular weight = 58,000 g/mol (with polystyrene |
| | standard) available from SABIC (PC 105) |
| PC2 | Bisphenol A polycarbonate manufactured using an interfacial process, |
| | having a melt volume rate of 13 cc/10 min (ISO 1133, 300° C., 1.2 kg) |
| | and weight average molecular weight = 42,000 g/mol (with polystyrene |
| | standard) available from SABIC (PC 175) |
| PC3 | Polycarbonate produced via the melt transesterification of diphenyl |
| | carbonate and bisphenol A, and having a melt volume rate of 6 cc/10 min |
| | (ISO 1133, 300° C., 1.2 kg) available from SABIC (PC 102L) |
| PC4 | Polycarbonate produced via the melt transesterification of diphenyl |
| | carbonate and bisphenol A, and having a melt volume rate of 13 |
| | cc/10 min (ISO 1133, 300° C., 1.2 kg) available from SABIC (PC 172L) |
| IM1 | HRG ABS (Acrylonitrile Butadiene Styrene) from Kumho (K181) with 55- |
| | 60% Butadiene content |
| IM2 | Paraloid MBS EXL 2550J core shell impact modifier commercially |
| | available from Dow |
| IM3 | Mitsubishi Metablen S-2001, Siloxane-BA-MMA terpolymer (CAS |
| | No.143106-82-5) available from Mitsubishi Chem Corp |
| FR1 | Phosphoric acid, (1-methylethylidene)di-4,1-phenylene tetraphenyl |
| | ester available from Wangsheng |
| FR2 | Oligomeric solid phosphate ester flame retardant, Fyrolflex Sol-DP - |
| | Pastilles available from ICL |
| FR3 | Cyclic Phenoxyphosphazene oligomer FR, grade name Rabitle FP-110 |
| | available from Fushimi Pharmaceutical |
| FR4 | Phenoxycyclotriphosphazene FR, grade name HPCTP available from |
| | Weihai Jinwei (CAS No. 1184-10-7) |
| FR5 | Cyclic Phenoxyphosphazene oligomer FR, grade name SPB-100 |
| | available from Otsuka Chemical Co., Ltd. Japan (CAS No. 260408-02-4) |
| TSAN | SAN encapsulated PTFE available from SABIC (CAS No. 9003-54-7) |
| TALC | Luzenac Talc 3CA (CAS No. 14807-96-6) |
| KAOLIN | Hydrated Aluminum Silicate, grade name ASP G90 available from BASF |
| | (CAS No 1332-58-7) |
| PETS | Pentaerythritol tetrastearate (CAS No. 115-83-3) |
| AO1 | Primary antioxidant, Pentaerythritol tetrakis(3-(3,5-di-tert-butyl-4- |
| | hydroxyphenyl)propionate), CAS No. 6683-19-8, Commercially available |
| | as Irganox 1010 |
| AO2 | Secondary antioxidant, tris(2,4-di-tert.-butylphenyl)phosphite, CAS |
| | No. 31570-04-4, commercially available from BASF as Irgafos 168 |

### Comparative Examples (CE1-CE3) and Examples (E1-E12): Table 2

TABLE 2
Formulations and properties for the thermoplastic compositions

| Sample # | CE1 | CE2 | CE3 | E1 | E2 | E3 | E4 | E5 | E6 | E7 | E8 | E9 | E10 | E11 | E12 |
|---|---|---|---|---|---|---|---|---|---|---|---|---|---|---|---|
| PC1 | 30.0 | | | 30.0 | 30.0 | 30.0 | 30.0 | | | 23.3 | 23.3 | | | | |
| PC2 | 53.0 | | | 53.0 | 53.0 | 53.0 | 53.0 | | | 51.0 | 51.0 | | | | |
| PC3 | | 30.0 | 30.0 | | | | | 30.0 | 30.0 | 14.0 | 14.0 | 29.6 | 29.6 | 29.6 | 29.6 |
| PC4 | | 53.0 | 53.0 | | | | | 53.0 | 53.0 | | | 50.5 | 51.4 | 51.4 | 51.4 |
| IM1 | 5.5 | 5.5 | 5.5 | 5.5 | 5.5 | 5.5 | 5.5 | 5.5 | 5.5 | | | 5.5 | 5.5 | 5.5 | 5.5 |
| IM2 | | | | | | | | | | 1.7 | 1.7 | | | | |
| IM3 | | | | | | | | | | | | 3.0 | | | |
| FR1 | 10.0 | | | 7.5 | 5.0 | 7.5 | 5.0 | 7.5 | 5.0 | 2.5 | 2.5 | 7.5 | 1.0 | 1.0 | 1.0 |
| FR2 | | 10.0 | | | | | | | | | | | 1.0 | 1.0 | 1.0 |
| FR3 | | | 10.0 | 2.5 | 5.0 | | | 2.5 | 5.0 | 5.0 | 5.0 | 2.5 | | 10.0 | |
| FR4 | | | | | | 2.5 | 5.0 | | | | | | 10.0 | | |
| FR5 | | | | | | | | | | | | | | | 10.0 |
| TSAN | 1.0 | 1.0 | 1.0 | 1.0 | 1.0 | 1.0 | 1.0 | 1.0 | 1.0 | 1.0 | 1.0 | 1.0 | 1.0 | 1.0 | 1.0 |
| KAOLIN | | | | | | | | | | 1.0 | | | | | |
| TALC | | | | | | | | | | | 1.0 | | | | |
| PETS | 0.3 | 0.3 | 0.3 | 0.3 | 0.3 | 0.3 | 0.3 | 0.3 | 0.3 | 0.3 | 0.3 | 0.3 | 0.3 | 0.3 | 0.3 |
| AO1 | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 |
| AO2 | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 |
| Total | 100.0 | 100.0 | 100.0 | 100.0 | 100.0 | 100.0 | 100.0 | 100.0 | 100.0 | 100.0 | 100.0 | 100.0 | 100.0 | 100.0 | 100.0 |
| UL-94 | V0 | V2 | V2 | V0 | V0 | V0 | V0 | V0 | V0 | V0 | V0 | V0 | V0 | V0 | V0 |
| @ 0.75 | | | | | | | | | | | | | | | |
| mm | | | | | | | | | | | | | | | |
| TFOT | 15.5 | 17.4 | 18.1 | 20.1 | 22.5 | 24.5 | 17.9 | 21.75 | 13.8 | 16.3 | 16.5 | 35.4 | 29.4 | 16.3 | 22.7 |
| @ | | | | | | | | | | | | | | | |
| 0.75 mm | | | | | | | | | | | | | | | |
| (s) | | | | | | | | | | | | | | | |
| UL-94 | V0 | V0 | V0 | V0 | V0 | V0 | V0 | V0 | V0 | V0 | V0 | V0 | NM | NM | NM |
| @ 1.0 | | | | | | | | | | | | | | | |
| mm | | | | | | | | | | | | | | | |
| TFOT | 12.9 | 13.9 | 21.6 | 12.5 | 14.8 | 10.9 | 12.8 | 14.7 | 13.5 | 12.8 | 12.3 | 28.7 | NM | NM | NM |
| @ 1.0 | | | | | | | | | | | | | | | |
| mm (s) | | | | | | | | | | | | | | | |
| ASTM | 98 | 383 | 513 | 316 | 459 | 599 | 619 | 493 | 578 | 369 | 393 | 430 | 652 | 832 | 749 |
| NII@3.2 | | | | | | | | | | | | | | | |
| mm | | | | | | | | | | | | | | | |
| (23° C.) | | | | | | | | | | | | | | | |
| J/m | | | | | | | | | | | | | | | |
| ASTM | 92.4 | 97.3 | 56.5 | 101.0 | 102.0 | 112.0 | 125.0 | 101.7 | 113 | 70.0 | 82.2 | 96.6 | NM | NM | NM |
| NII@3.2 | | | | | | | | | | | | | | | |
| mm | | | | | | | | | | | | | | | |
| (0° C.) | | | | | | | | | | | | | | | |
| J/m | | | | | | | | | | | | | | | |
| MFR | 15.8 | 13.1 | 8.6 | 15.2 | 13.9 | 13.8 | 13.1 | 14.6 | 15.0 | 12.7 | 13.3 | 7.8 | 9.6 | 10.1 | 10.7 |
| HDT | 99 | 101 | 99 | 99 | 99 | 103 | 105 | 103 | 106 | 107 | 113 | 100 | 96 | 96 | 94 |

NM means Not Measured

The amounts in Table 2 are in weight percent based on the total weight of the composition. In all the examples, the total amount of components, equals 100 weight percent. Table 2 shows that polycarbonate compositions comprising an impact modifier and only one type of FR (CE1 to CE3) do not show a desired combination of high impact strength with good flammability property in terms of UL94 V0 at 0.75 mm. However, a polycarbonate composition comprising an impact modifier (ABS or MBS) and a combination of flame-retardant additives comprising a cyclic phosphazene and an oligomeric phosphate (E1 to E4) does show improved impact properties, especially at room temperature. Along with that a V0 flame retardancy rating in accordance with UL94 V0 at 0.75 mm is achieved. Similar properties can be achieved when the composition comprises polycarbonate prepared by either interfacial process (E3 and E4) or by melt process (E5 and E6). Examples E7 and E8 comprise talc or kaolin additives along with anti-drip agent TSAN. It can be seen that even with lower wt. % of FR additives, similar properties could be achieved in presence of talc or kaolin. Addition of a silicon-acrylate composite rubber impact modifier in addition to ABS in E9 led to further increase in impact properties compared to E1 while showing similar flame retarding properties.

Furthermore, it can be seen from Table 2 that between E10, E11 and E12, the impact properties of E11 and E12 are better than that of E10, while showing comparable flame retarding properties. The composition of E10 comprises cyclic phenoxyphosphazene containing only trimers (with k=1), whereas the composition of E11 comprises cyclic phosphazene containing oligomers of phenoxyphosphazene up to 8 repeating units (k=1 to k=8). Therefore presence of some oligomeric components of the phosphazene in the FR additive helps to improve the impact properties in the composition with comparable flame retarding properties. Also all the examples, the HDT and the MFR is within the acceptable range as compared to the comparative examples.

1. A thermoplastic composition comprising, based on the weight of the composition,
(A) 60 to 95 wt. % of aromatic polycarbonate,
(B) 3 to 15 wt. % of impact modifier,
(C) 2 to 20 wt. % of a flame-retardant additive comprising at least one cyclic phosphazene (C-1) and at least one oligomeric phosphate (C-2)
(D) 0 to 5 wt. % of other components;
wherein, the combined amounts of (A) to (D) is 100 wt. %,
and wherein the composition has:
a notched Izod impact resistance determined in accordance with ASTM D-256 at a temperature of 23° C. of at least 300 J/m;
a melt flow rate determined in accordance with ASTM D1238 (300° C., 1.2 kg) of at least 7.0 g/10 min; and
a UL94 rating of V0 at a thickness of 0.75 mm.

2. The thermoplastic composition of claim 1 wherein the wt. % ratio (C-1) to (C-2) is 10:90 to 90:10.

3. The thermoplastic composition of claim 1 wherein the cyclic phosphazene (C-1) is selected from the group consisting of propoxyphosphazene, phenoxyphosphazene, methylphenoxyphosphazene, aminophosphazene and fluoroalkylphosphazenes and phosphazenes having the following structure (X) 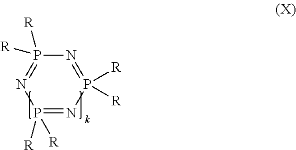
where the radicals R are identical or different and are each an amine radical, in each case optionally halogenated, C1- to C8-alkyl, C1- to C8-alkoxy, C5- to C6-cycloalkyl in each case optionally substituted by alkyl and/or halogen, C6- to C20-aryloxy in each case optionally substituted by alkyl and/or halogen, and/or hydroxy, C7- to C12-aralkyl in each case optionally substituted by alkyl and/or halogen, a halogen radical, or an OH radical; and k is an integer from 1 to 10.

4. The thermoplastic composition of claim 3 wherein the cyclic phosphazene (C-1) has a proportion of trimer (k=1) from 50 to 98 mol %.

5. The thermoplastic composition of claim 1 wherein the oligomeric phosphate (C-2) is selected from the group consisting of bisphenol A bis (diphenyl phosphate), resorcinol (diphenyl phosphate), oligomeric solid phosphate ester and mixtures of two or more of the foregoing.

6. The thermoplastic composition of claim 1 wherein the impact modifier is selected from the group consisting of acrylonitrile-butadiene-styrene impact modifiers, methyl methacrylate-butadiene-styrene impact modifiers, ethylene-acrylate copolymer impact modifiers, ethylene-acrylate-glycidyl copolymer impact modifiers and mixtures of two or more of the foregoing.

7. The thermoplastic composition of claim 5 wherein the impact modifier further comprises 1 to 5 wt. % of a silicon-acrylate composite rubber comprising a polyorganosiloxane rubber component and a polyalkyl (meth)acrylate rubber component.

8. The thermoplastic composition of claim 1 wherein the other components (D) comprises, based on the weight of the composition, from 0.01 to 2 wt. % of anti-drip agent.

9. The thermoplastic composition of claim 1 wherein the other components (D) comprises, based on the weight of the composition, from 0.01 to 3 wt. % of one or more selected from the group consisting of talc, kaolin, and mica.

10. The thermoplastic composition of claim 1 wherein the aromatic polycarbonate comprises two or more aromatic polycarbonates having different melt flow rates.

11. The thermoplastic composition of claim 1 wherein the aromatic polycarbonate comprises or consists of bisphenol A polycarbonate or a mixture of bisphenol A polycarbonates.

12. The thermoplastic composition of claim 1 wherein the aromatic polycarbonate has a weight average molecular weight of 15,000 to 60,000 g/mol determined using gel permeation chromatography with polycarbonate standards.

13. The thermoplastic composition of claim 1 wherein the composition has a heat distortion temperature of at least 90° C., as determined in accordance with ASTM D648 standard at a load of 0.45 MPa.

14. An article comprising or consisting of the thermoplastic composition of claim 1.

15. A method of manufacturing an article comprising molding the thermoplastic composition of claim 1.
